(19) United States
(12) Patent Application Publication
(10) Pub. No.: US 2025/0168484 A1
(43) Pub. Date: May 22, 2025

(54) CONTROL METHOD OF PHOTOGRAPHING DEVICE AND PHOTOGRAPHING DEVICE

(71) Applicant: Arashi Vision Inc., Shenzhen (CN)

(72) Inventors: Guo SHIJIA, Shenzhen (CN); Long LIANGQU, Shenzhen (CN)

(73) Assignee: Arashi Vision Inc., Shenzhen (CN)

(21) Appl. No.: 18/953,298

(22) Filed: Nov. 20, 2024

(30) Foreign Application Priority Data
Nov. 20, 2023 (CN) 2023115563412

(51) Int. Cl. H04N 23/61; G06V 10/82; G06V 20/40; H04N 23/63; H04N 23/65; H04N 23/667

(52) U.S. Cl. CPC H04N 23/61; G06V 10/82; G06V 20/46; H04N 23/632; H04N 23/651; H04N 23/667

(57) ABSTRACT

Embodiments of the present application disclose a method for controlling a photographing device. The method may include obtaining a target state of a target object; determining that the target state of the target object meets a preset condition; and storing pre-shot photos and/or pre-shot videos of the photographing device within a preset time interval. The photographing device may be in a pre-shot mode, and the preset time interval may include an interval from a target moment when the target state of the target object meets the preset condition to a first preset moment prior to the target moment.

### CROSS-REFERENCE TO RELATED APPLICATION

The present application claims priority to Chinese Patent Application No. CN2023115563412, filed Nov. 20, 2023, the entire content of which being incorporated herein by reference in its entirety.

### TECHNICAL OF FIELD

The present application relates to the field of photographing technology, and in particular to a control method for a photographing device and a photographing device.

### BACKGROUND

During a fishing process, a formal recording mode of a photographing device can be turned on to record a fishing video. However, fishing generally takes a long time, and if the video is continuously recorded, the storage space of the photographing device may be tight.

### SUMMARY

In a first aspect, the present application provides a method for controlling a photographing device, comprising: obtaining a target state of a target object; determining that the target state of the target object meets a preset condition; and storing pre-shot photos and/or pre-shot videos of the photographing device within a preset time interval.

The photographing device may be in a pre-shot mode, and the preset time interval may include an interval from a target moment when the target state of the target object meets the preset condition to a first preset moment prior to the target moment.

In a second aspect, the present application further provides a video recognition device, comprising:
an acquisition module, configured to acquire a target state of a target object when the photographing device is in a pre-shot mode;
a storage module, configured to store pre-shot photos and/or pre-shot videos of the photographing device within a preset time interval when the target state of the target object meets the preset conditions; the preset time interval includes an interval from a target moment when the target state of the target object meets the preset condition to a first preset moment prior to the target moment.

In a third aspect, the present application further provides a photographing device, comprising at least one camera, at least one processor, and at least one memory, the at least one camera is configured to collect pre-shot photos and/or pre-shot videos; and the at least one memory stores computer program instructions,
wherein the at least one processor is configured to, when executing the computer program instruction, obtain a target state of a target object; determine that the target state of the target object meets a preset condition; and store pre-shot photos and/or pre-shot videos of the photographing device within a preset time interval,
wherein the photographing device is in a pre-shot mode, and the preset time interval includes an interval from a target moment when the target state of the target object meets the preset condition to a first preset moment prior to the target moment.

In a fourth aspect, the present application further provides a non-transitory storage medium, wherein the non-transitory storage medium stores a plurality of instructions, wherein the plurality of instructions, when executed by at least one processor, cause the at least one processor to execute the method for controlling a photographing device according to one embodiment of the present disclosure.

In a fifth aspect, the present application further provides a computer program product, comprising a computer program, which implements the steps of the above-mentioned first aspect when executed by a processor.

### BRIEF DESCRIPTION OF THE DRAWINGS

In order to more clearly illustrate the technical solutions in embodiments of the present disclosure, the accompanying drawings to be used in the embodiments will be briefly introduced below, and it will be obvious that the accompanying drawings in the following description are only some of the embodiments of the present disclosure, and that for the person of ordinary skill in the field, other accompanying drawings can be obtained based on these drawings, without giving creative labor.

FIG. 1 is a diagram of an application environment of a method for controlling a photographing device in one embodiment of the present disclosure;

FIG. 2 is a schematic flow chart of a method for controlling a photographing device in one embodiment of the present disclosure;

FIG. 3 is a schematic diagram of a flow chart of a method for acquiring a target state in one embodiment of the present disclosure;

FIG. 4 is a schematic diagram of a flow chart of a method for determining a target detection frame in one embodiment of the present disclosure;

FIG. 5 is a schematic diagram of a flow chart of a method for determining a target detection frame in another embodiment of the present disclosure;

FIG. 6 is a schematic diagram of a flow chart of a method for determining a target detection frame in one embodiment of the present disclosure;

FIG. 7 is a schematic flow chart of a method for acquiring a target state in one embodiment of the present disclosure;

FIG. 8 is a diagram of showing an application environment of a method for controlling a photographing device according to one embodiment of the present disclosure;

FIG. 9 is a schematic flow chart of a method for acquiring a target state in another embodiment of the present disclosure;

FIG. 10 is a schematic diagram of a flow chart of a method for determining a recurrent neural network model in one embodiment of the present disclosure;

FIG. 11 is a structural block diagram of a control device for a photographing device in one embodiment of the present disclosure;

FIG. 12 is a diagram showing an internal structure of a computer device in one embodiment of the present disclosure.

### DETAILED DESCRIPTION

In order to make the purpose, technical solution and advantages of the present application more clearly understood, the present application is further described in detail below in conjunction with the accompanying drawings and embodiments. It should be understood that the specific embodiments described herein are only used to explain the present application and are not used to limit the present application.

A fish alarm is usually set when fishing. The fish alarm mainly analyzes changes in a tension sensor and compares a tension value collected by the tension sensor with a preset tension value to prompt a user whether a fish has bitten the hook. However, due to interference of external factors, judgment of whether a fish has bitten the hook is often inaccurate, so a wonderful video clip obtained is often inaccurate. Moreover, the fish alarm cannot obtain an end time of the video recording. Furthermore, in order to reduce excessive usage of storage space of a photographing device, formal recording can be performed during only wonderful moments such as a moment of catching a fish, but at this time the user is busy with the operation and has no time to turn on the photographing device to record the wonderful video clips during the fishing process. Therefore, the present application proposes a control method and a photographing device for solving the above and other technical problems.

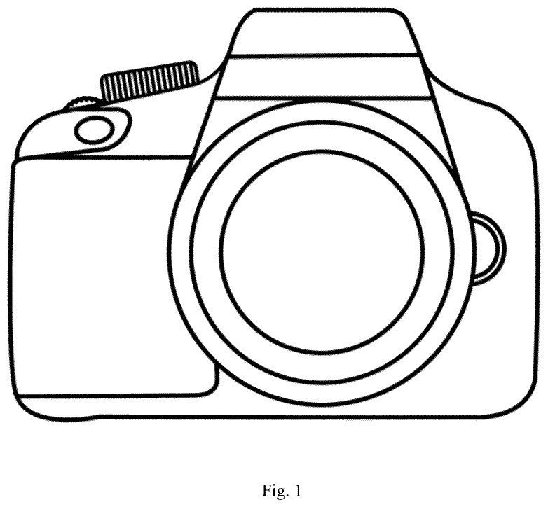

A control method of a photographing device provided in one embodiment of the present application can be applied in an application environment shown in FIG. 1. FIG. 1 is a schematic diagram of a photographing device, and the photographing device identifies a target state of a target object in a pre-shot photo and/or pre-shot video according to the pre-shot photo and/or pre-shot video in a pre-shot mode, and stores the pre-shot photo and/or the pre-shot video of the photographing device within a preset time interval when the target state of the target object meets a preset condition.

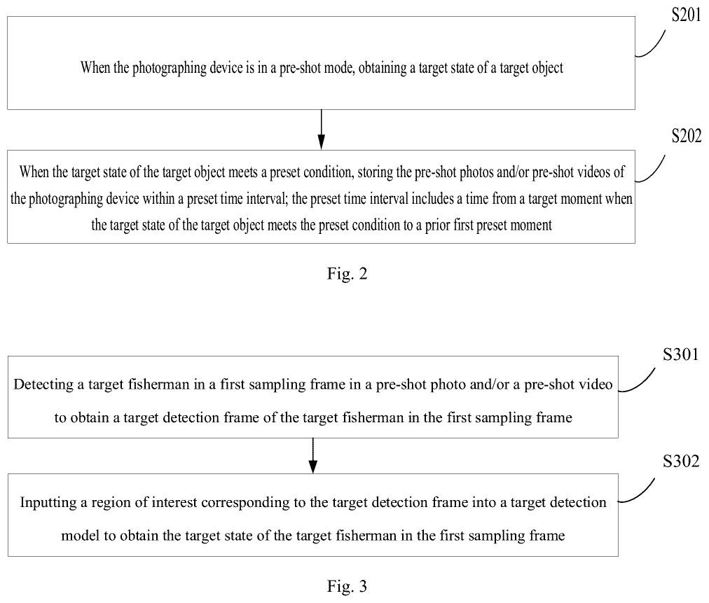

In one embodiment, as shown in FIG. 2, a control method for a photographing device is provided, which is described by taking the method applied to the photographing device in FIG. 1 as an example, and includes the following S201 to S202, wherein:

S201, when the photographing device is in a pre-shot mode, obtaining a target state of a target object.

When the photographing device is in the pre-shot mode, the photographing device will store the pre-shot photos and/or pre-shot videos of a preset time in advance. For example, when the photographing device is in a fishing scene and the pre-shot mode is turned on, the user can set a shooting resolution, anti-shake switch, FOV, and frame ratio, as well as a pre-recording duration, which can be 5 s, 10 s, 20, 30 s, etc. After setting, click a shooting button and the photographing device starts pre-recording.

The photographing device may include any one of a sports camera, a panoramic camera, a drone or a gimbal camera.

When the photographing device is in the pre-shot mode, it shoots in the lowest possible power consumption mode in exchange for long battery life. If both the front and rear screens are in off state, the user can be informed that the photographing device is photographing by means of an indicator light.

In one embodiment, the target object is different for different photographing scenes. For example, in a fishing scene, the target object may be a target fisherman, a fishing rod, a fishing line, a fish, etc.

In this embodiment, when the photographing device is in the pre-shot mode, the target state of the target object is obtained by using a neural network model on the pre-shot photos and/or pre-shot videos collected by the photographing device. For example, when the target object is a target fisherman, the target state may be a state of reeling in the fishing line; when the target object is the fishing rod, the target state may be a state of casting the rod, a state of reeling in the rod, etc.

S202, when the target state of the target object meets a preset condition, storing the pre-shot photos and/or pre-shot videos of the photographing device within a preset time interval; the preset time interval includes an interval from a target moment when the target state of the target object meets the preset condition to a prior first preset moment, that is, a first preset moment prior to the target moment.

In this embodiment, when the photographing device is in the pre-shot mode, the pre-shot photos and/or pre-shot videos are automatically identified. When it is identified that the target state of the target object meets the preset condition, the photographing device immediately switches from a low-power identification state to a state of starting recording to drive the photographing device to start storage (equivalent to pressing the shutter button in the pre-shot mode to start recording). After entering the recording, the screen of the photographing device lights up so that the user can see that the photographing device has started photographing. For example, when the photographing device is in the pre-shot mode, when it is identified that a fish is hooked or the fisherman is raising the fishing rod, that is, when the target state of the target object meets the preset condition, the photographing device is driven to start photographing and store the pre-shot fishing photos and/or pre-shot fishing videos of the photographing device within the preset time interval.

In the control method of the above-mentioned photographing device, when the photographing device is in the pre-shot mode, the target state of the target object is obtained, and when the target state of the target object meets the preset condition, the pre-shot photos and/or pre-shot videos of the photographing device within the preset time interval are stored; the preset time interval includes the interval from a moment when the target state of the target object meets the preset condition to a prior first preset moment. In the embodiment of the present application, when the photographing device is in the pre-shot mode, by identifying the target state of the target object, the pre-shot photos and/or pre-shot videos of the photographing device within the preset time interval are stored, which helps the user record the pre-shot photos and/or pre-shot videos, does not need to manually start the recording mode of the photographing device, and reduces the usage of the storage space of the photographing device. Moreover, the preset time interval includes the interval from the moment when the target state of the target object meets the preset condition to the prior first preset moment, which improves integrity of the stored pre-shot photos and/or pre-shot videos.

In one embodiment, the preset time interval includes the interval from a moment when the target state of the target object meets the preset condition to a second preset time thereafter, that is, a second preset time after the moment.

In this embodiment, the preset time interval includes the interval from the moment when the target state of the target object meets the preset condition to the second preset time thereafter, and the second preset time can be determined by setting the duration to control the photographing device to stop storing the pre-shot photos and/or pre-shot videos of the preset time interval. For example, if the duration is set to 30 seconds, the storage will automatically end after 30 seconds starting from the first preset time.

In one embodiment, a recognition algorithm can also be used to determine the moment when the target state of the target object does not meet the preset condition as the second preset moment, and control the photographing device to stop storing the pre-shot photos and/or pre-shot videos of the preset time interval.

In the embodiment of the present application, the preset time interval includes the time from the moment when the target state of the target object meets the preset condition to a second preset time thereafter, so that the storage of pre-shot photos and/or pre-shot videos is more flexible.

In one embodiment, when the target state of the target object meets the preset condition, after storing the pre-shot photos and/or pre-shot videos of the photographing device within a preset time interval, the method also includes: generating a target video based on the pre-shot photos and/or pre-shot videos stored in the pre-shot mode.

In this embodiment, after obtaining the pre-shot photos and/or pre-shot videos, the target video can be generated by editing the pre-shot photos and/or pre-shot videos, adding special effects, etc.

In one embodiment, the control method of the above-mentioned photographing device further includes: storing current pre-shot photo and/or pre-shot video when the target state of the target object meets a preset condition.

In this embodiment, when the target state of the target object meets the preset condition, the current pre-shot photos and/or pre-shot videos are stored, thereby reducing redundancy of the pre-shot photos and/or pre-shot videos.

In one embodiment, a possible implementation method for obtaining the target state of the target object when the target object is a target fisherman including the following steps:

S301, detecting a target fisherman in a first sampling frame in a pre-shot photo and/or a pre-shot video to obtain a target detection frame of the target fisherman in the first sampling frame.

In this embodiment, sampling is performed from a fishing video pre-shot by a photographing device to obtain a first sampling frame, and a target object is detected using a target detection algorithm to obtain a target detection frame of the target object in the first sampling frame.

Optionally, the first sampling frame may be one video frame or multiple video frames. For example, the first sampling frame may be eight video frames collected in one second or one video frame collected in one second.

If the first sampling frame includes a video frame, the detection frame of the target object in the video frame is used as the target detection frame; if the first sampling frame includes multiple video frames, a first detection frame is obtained for each video frame, and the target detection frame is determined from the each first detection frame.

S302, inputting a region of interest corresponding to the target detection frame into a target detection model to obtain the target state of the target fisherman in the first sampling frame.

In this embodiment, the region of interest corresponding to the target detection frame is input into the target detection model to obtain a probability of the target fisherman in each state in the first sampling frame, thereby determining the target state of the target fisherman according to the probability in each state. The target detection model is a pre-trained model integrated into the photographing device.

In one embodiment, the target fisherman in the first sampling frame of the pre-shot photo and/or pre-shot video is detected to obtain a target detection frame of the target fisherman in the first sampling frame, and the region of interest corresponding to the target detection frame is input into the target detection model to obtain the target state of the target fisherman in the first sampling frame. In an embodiment of the present application, the target state is determined based on the region of interest of the target detection frame, which reduces the input size of the image input into the probability detection model, reduces background interference, and improves efficiency of determining the target state.

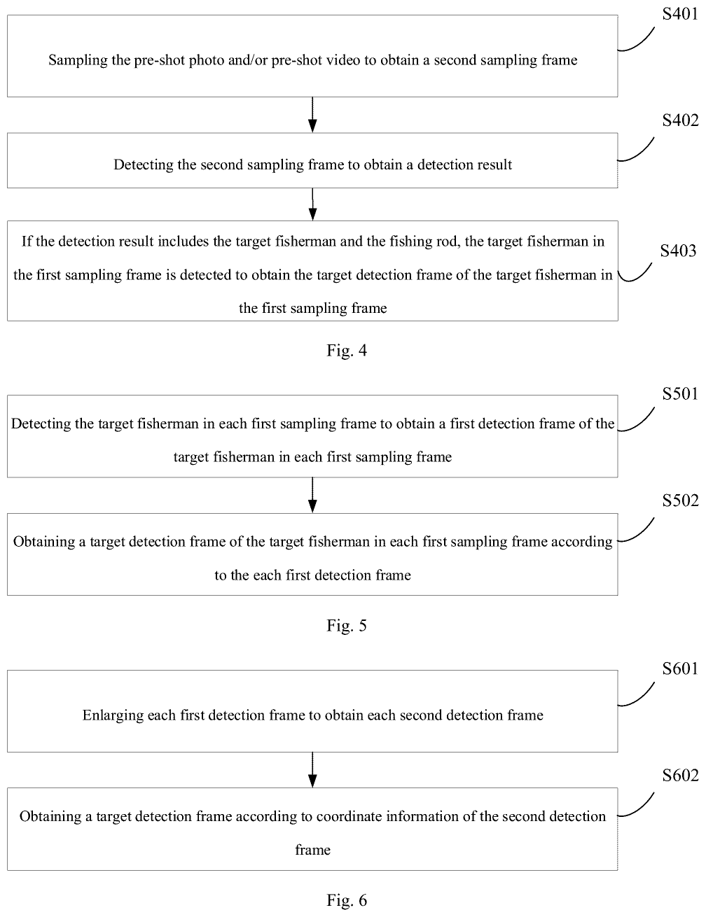

FIG. 4 is a flow chart of a method for determining a target detection frame in an embodiment. As shown in FIG. 4, the embodiment of the present application is related to detecting a target fisherman in a first sampling frame in a pre-shot photo and/or a pre-shot video, and obtaining a possible implementation method of determining the target detection frame of the target fisherman in the first sampling frame, which includes the following steps:

S401, sampling the pre-shot photo and/or pre-shot video to obtain a second sampling frame;

S402: detecting the second sampling frame to obtain a detection result.

S403: if the detection result includes the target fisherman and the fishing rod, the target fisherman in the first sampling frame is detected to obtain the target detection frame of the target fisherman in the first sampling frame.

In this embodiment, before detecting the first sampling frame, the pre-shot photos and/or pre-shot videos may be periodically sampled to obtain a second sampling frame. For example, the second sampling frame may be a video frame acquired per second, and the target fisherman and the fishing rod in the second sampling frame are detected. If the detection result includes the target fisherman and the fishing rod, that is, the target fisherman and the fishing rod appear at the same time, the target fisherman in the first sampling frame is detected to obtain the target detection frame of the target fisherman in the first sampling frame.

If the detection result includes only the target fisherman or only the fishing rod, continue to sample the pre-shot photos and/or pre-shot videos to obtain a second sampling frame, and detect the second sampling frame to obtain the detection result until the detection result includes the target fisherman and the fishing rod.

In one embodiment, the pre-shot photo and/or pre-shot video is sampled to obtain a second sampling frame, and the second sampling frame is detected to obtain a detection result. If the detection result includes the target fisherman and the fishing rod, the target fisherman in the first sampling frame is detected to obtain a target detection frame of the target fisherman in the first sampling frame. In an embodiment of the present application, whether to detect the first sampling frame is determined based on the detection result of the second sampling frame. Only when the detection result includes both the target fisherman and the fishing rod, the target fisherman in the first sampling frame is subsequently detected to obtain a target detection frame of the target fisherman in the first sampling frame, thereby improving accuracy of determining the target detection frame.

FIG. 5 is a flow chart of a method for determining a target detection frame in one embodiment. As shown in FIG. 5, the embodiment of the present application relates to a possible implementation method of detecting a target fisherman in a first sampling frame to obtain a target detection frame of the target fisherman in the first sampling frame when there are a number of first sampling frames, including:

S501, detecting the target fisherman in each first sampling frame to obtain a first detection frame of the target fisherman in each first sampling frame.

In this embodiment, the target fisherman in each first sampling frame is detected to obtain the first detection frame of the target fisherman in each first sampling frame. For example, the first sampling frame includes 8 video frames, and the first detection frames are Box11, Box21, . . . Box81. The coordinate information of Box1 is expressed as (x101, y101, x111, y111), and the coordinate information of Box2 is expressed as (x201, y201, x211, y211). Among them, if the coordinate origin of the first sampling frame is the upper left corner, (x101, y101) is the coordinate information of the upper left corner of Box1, (x111, y111) is the coordinate information of the lower right corner of Box1, (x201, y201) is the coordinate information of the upper left corner of Box2, and (x211, y211) is the coordinate information of the lower right corner of Box2. If the coordinate origin of the first sampling frame is the lower left corner, (x101, y101) is the coordinate information of the lower left corner of Box1, (x111, y111) is the coordinate information of the upper right corner of Box1, (x201, y201) is the coordinate information of the lower left corner of Box2, and (x211, y211) is the coordinate information of the upper right corner of Box2.

S502: Obtaining a target detection frame of the target fisherman in each first sampling frame according to the each first detection frame.

The target detection frame of the target fisherman in each first sampling frame can be obtained based on each first detection frame, and the first detection frame can be enlarged to obtain each second detection frame, and the target detection frame can be obtained based on each second detection frame.

In an embodiment of the present application, the target fisherman in each first sampling frame is detected to obtain a first detection frame of the target fisherman in each first sampling frame, and a target detection frame of the target fisherman in each first sampling frame is obtained based on each first detection frame, thereby improving accuracy of determining the target detection frame.

FIG. 6 is a flow chart of a method for determining a target detection frame in one embodiment. As shown in FIG. 6, the embodiment of the present application relates to a possible implementation method of obtaining a target detection frame of a target fisherman in each first sampling frame according to each first detection frame, including:

S601, enlarging each first detection frame to obtain each second detection frame.

In this embodiment, in order to reduce deviation and ensure that the target object is located in the detection frame, each first detection frame can also be enlarged to obtain each second detection frame. For example, taking the above Box11 as an example, any coordinate value in Box 11 can be changed, or multiple coordinate values can be changed at the same time, so as to enlarge Box11 to obtain the second detection frame Box12.

S602: obtaining a target detection frame according to coordinate information of the second detection frame.

In this embodiment, an area of each second detection frame can be obtained according to the coordinate information of each second detection frame, and the second detection frame with the largest area is used as the target detection frame. For example, it is assumed that the second detection frames are Box12, Box22, . . . Box82. The coordinate information of Box12 can be expressed as (x102, y102, x112, y112), and the coordinate information of Box2 can be expressed as (x202, y202, x212, y212). The area of each second detection frame is obtained according to Box12, Box22, . . . Box82. If Box52 is the detection frame with the largest area, Box52 is used as the target detection frame.

In one embodiment, the coordinate information of the second detection frame includes first coordinate information and second coordinate information, the first coordinate information includes a first coordinate and a second coordinate, and the second coordinate information includes a third coordinate and a fourth coordinate. Obtaining the target detection frame according to the coordinate information of the second detection frame may include: taking a minimum coordinate of each first coordinate as the first target coordinate, and taking a minimum coordinate of each second coordinate as the second target coordinate; taking a maximum coordinate of each third coordinate as the third target coordinate, and taking a maximum coordinate of each fourth coordinate as the fourth target coordinate; obtaining the target detection frame according to the first target coordinate, the second target coordinate, the third target coordinate, and the fourth target coordinate.

In this embodiment, taking the above-mentioned Box12, Box22, . . . Box82 as an example, (x102, y102) is the first coordinate information, (x112, y112) is the second coordinate information, x102 is the first coordinate, y102 is the second coordinate, x112 is the third coordinate, and y112 is the fourth coordinate. The minimum coordinate is obtained from the 8 first coordinates as the first target coordinate, the minimum coordinate is obtained from the 8 second coordinates as the second target coordinate, the maximum coordinate is obtained from the 8 third coordinates as the third target coordinate, and the maximum coordinate is obtained from the 8 fourth coordinates as the fourth target coordinate. That is, the first target coordinate x_min=min(x102, x202, . . . , x802), the second target coordinate y_min=min(y102, y202, . . . , y802), the third target coordinate x_max=max(x112, x212, . . . , x812), the fourth target coordinate y_max=max(y112, y212, . . . , y812), and the coordinate information of the target detection box is (x_min, y_min, x_max, y_max).

In an embodiment of the present application, each first detection frame is enlarged to obtain each second detection frame, and the largest detection frame is determined as the target detection frame based on the coordinate information of each second detection frame, thereby reducing the possible deviation caused by the first detection frame, so that the determined target detection frame can ensure integrity of the target fisherman.

An embodiment of the present application relates to a possible implementation method for storing pre-shot photos and/or pre-shot videos of a photographing device within a preset time interval when the target state of the target object meets the preset condition, comprising the following steps: when the target state of the target object meets the first preset condition, controlling the photographing device to enter the recording state; when the target state of the target object meets the second preset condition, controlling the photographing device to exit the recording state to store the pre-shot photos and/or pre-shot videos.

In one embodiment, if the target state of the target fisherman is the fishing line reeling state, it is determined that the target state of the target fisherman meets the first preset condition; if the target state is not the fishing line reeling state, it is determined that the target state of the target fisherman meets the second preset condition.

In this embodiment, the occurrence probability of the fishing line reeling action can also be determined based on the pre-shot photos and/or pre-shot videos and the probability detection model. If the occurrence probability of the fishing line reeling action is greater than a preset probability threshold, it is considered that the target state of the target fisherman is the fishing line reeling state, and the target state of the target fisherman meets the first preset condition, and the photographing device is controlled to enter the recording state.

If the probability of the fishing line reeling action is not greater than the preset probability threshold, it is considered that the target state of the target fisherman is a non-fishing line reeling state; alternatively, the video or photo after the recording state is turned on is sampled to obtain a third sampling frame, and target detection is performed on the third sampling frame. If there is a fish in the third sampling frame, it is determined that the state of the target fisherman is a non-fishing line reeling state, and the user can manually or remotely control the photographing device to exit the recording state by voice control/remote control to store pre-shot photos and/or pre-shot videos.

In one embodiment, when the user exits the recording state, the state can be put on standby for a preset time to prevent the user from viewing the stored pre-shot photos and/or pre-shot videos. If there is no operation after the preset time, the state continues to switch to the pre-shot mode, and the cycle repeats.

In an embodiment of the present application, when the target state of the target fisherman meets the first preset condition, the photographing device is controlled to enter the recording state; when the target state of the target object meets the second preset condition, the photographing device is controlled to exit the recording state to store pre-shot photos and/or pre-shot videos. The wonderful moments in the pre-shot photos and/or pre-shot videos can be automatically identified according to the target state of the target fisherman, helping the user to record wonderful video clips without manually starting the recording mode of the photographing device and reducing the use of storage space.

In one embodiment, if the first sampling frame includes multiple fishermen, a distance between each fisherman and the fishing rod is determined; and the fisherman corresponding to the shortest distance is taken as the target fisherman.

In this embodiment, taking the first sampling frame as a video frame as an example, if the first sampling frame includes multiple fishermen, each fisherman and fishing rod in the first sampling frame is detected to obtain a third detection frame corresponding to each fisherman and a fourth detection frame corresponding to the fishing rod, and the distance between each fisherman and the fishing rod is determined based on the coordinate information of each third detection frame and the coordinate information of the fourth detection frame, and the fisherman corresponding to the shortest distance is taken as the target fisherman.

In an embodiment of the present application, if the first sampling frame includes multiple fishermen, the distance between each fisherman and the fishing rod is determined; the fisherman corresponding to the shortest distance is taken as the target fisherman. In an embodiment of the present application, the target fisherman is determined based on the distance between each fisherman and the fishing rod. The implementation method is simple and the efficiency of determining the target fisherman is improved.

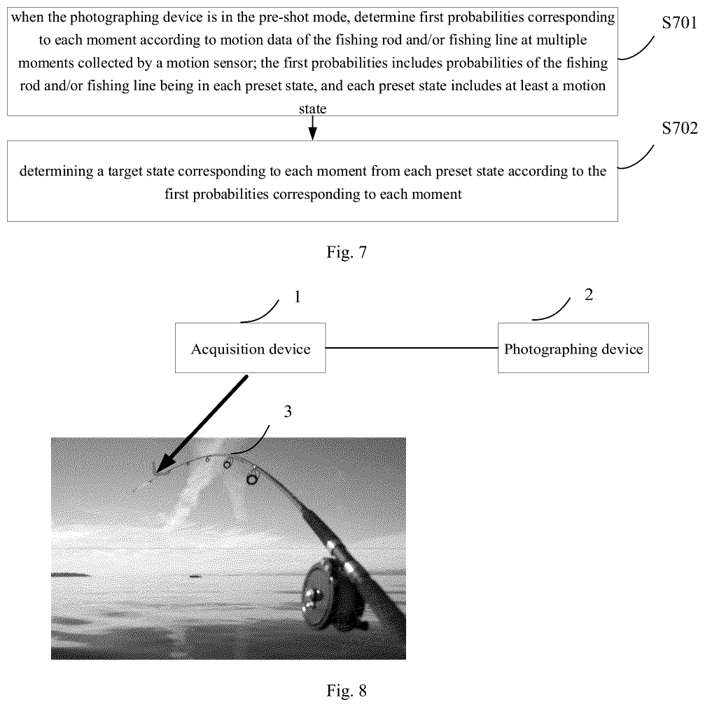

FIG. 7 is a flow chart of a method for acquiring a target state in one embodiment. As shown in FIG. 7, the embodiment of the present application relates to a possible implementation method for acquiring a target state of a target object when the target object is a fishing rod and/or a fishing line, including the following steps:

S701: when the photographing device is in the pre-shot mode, determine first probabilities corresponding to each moment according to motion data of the fishing rod and/or fishing line at multiple moments collected by a motion sensor; the first probabilities includes probabilities of the fishing rod and/or fishing line being in each preset state, and each preset state includes at least a motion state.

In one embodiment, the preset state may include a motion state and other states, the motion state may include a casting state and a reeling-in state, and the other states may include a static state.

In this embodiment, when the photographing device is in the pre-shot mode, as shown in FIG. 8, an acquisition device collects the motion data of the fishing rod and/or the fishing line in real time, and transmits the motion data to the photographing device via Bluetooth in real time. For example, the acquisition device is a gyroscope sensor, and the gyroscope sensor collects the motion vector m_t of the end of the fishing rod: [ac_x, ac_y, ac_z, v_x, v_y, v_z], ac_x, ac_y, ac_z represent acceleration values of the fishing rod projected to the x/y/z direction at time t, respectively and v_x, v_y, v_z represent angular velocity values of the fishing rod projected to the x/y/z direction at time t respectively.

The motion data at each moment is input into a probability prediction model to obtain the first probabilities at each moment. For example, the preset states include a casting state, a reeling state and a static state. The acceleration values and the angular velocity values at time t1 are input into the convolutional neural network model, and the probability of the casting state at time t1 is 0.2, the probability of the reeling state is 0.5, and the probability of the static state is 0.3.

S702: determining a target state corresponding to each moment from each preset state according to the first probabilities corresponding to each moment.

In this embodiment, the maximum probability of the first probabilities corresponding to each moment is determined, and the maximum probability of each moment is compared with a preset probability threshold. If the maximum probability is greater than the preset probability threshold, the preset state corresponding to the maximum probability is used as the target state.

In one embodiment, the preset state corresponding to the first probability corresponding to each moment may also be used as the target state.

In an embodiment of the present application, when the photographing device is in the pre-shot mode, the first probabilities corresponding to each moment are determined based on the motion data of the fishing rod and/or the fishing line at multiple moments collected by the motion sensor, and based on the first probabilities corresponding to each moment, the target state corresponding to each moment is determined from various preset states, thereby improving efficiency of the method for determining the target state.

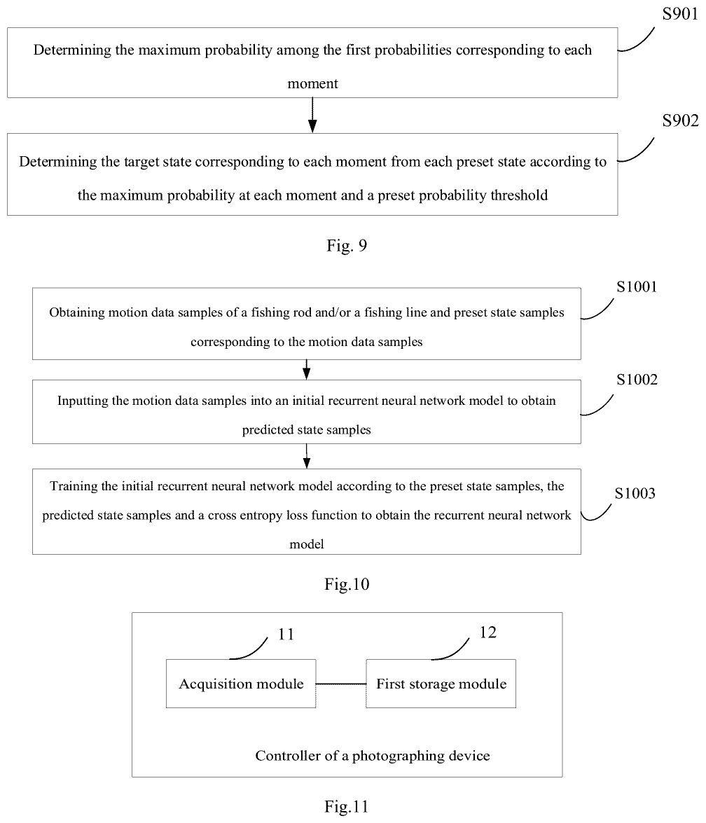

FIG. 9 is a flow chart of a method for acquiring a target state in one embodiment. As shown in FIG. 9, the embodiment of the present application relates to a possible implementation method of determining a target state corresponding to each moment from each preset state according to first probabilities corresponding to each moment, including the following steps:

S901, determining the maximum probability among the first probabilities corresponding to each moment.

S902, determining the target state corresponding to each moment from each preset state according to the maximum probability at each moment and a preset probability threshold.

In this embodiment, for first probabilities corresponding to each moment, the maximum probability is determined from the first probabilities. If the preset state corresponding to the maximum probability is a motion state, and the maximum probability is greater than the preset probability threshold, the target state corresponding to the moment is determined to be a motion state.

In one embodiment, a maximum probability may also be determined from the first probabilities. If the maximum probability is greater than a preset probability threshold, the target state corresponding to the moment is determined to be the preset state corresponding to the maximum probability.

In one embodiment, “according to the maximum probability at each moment and the preset probability threshold, the target state corresponding to each moment is determined from each preset state”, including: if the preset state corresponding to the maximum probability is a motion state, and the maximum probability is greater than the preset probability threshold, then the target state corresponding to the moment is determined to be a motion state; the motion state includes a casting rod state or a reeling rod state.

In this embodiment, if the preset state corresponding to the maximum probability is the casting state, and the maximum probability is greater than the preset probability threshold, then the target state is the casting state; if the preset state corresponding to the maximum probability is the reeling-in state, and the maximum probability is greater than the preset probability threshold, then the target state is the reeling-in state; if the preset state corresponding to the maximum probability is the casting state, but the maximum probability is less than the preset probability threshold, then the target state is the non-motion state, that is, the target state is other states; or, if the preset state corresponding to the maximum probability is other states, then the target state is other states.

In an embodiment of the present application, if the preset state corresponding to the maximum probability is a motion state, and the maximum probability is greater than the preset probability threshold, then the target state corresponding to the determination moment is a motion state. The present application determines the target state at the same time based on the preset state corresponding to the maximum probability and the relationship between the maximum probability and the preset probability threshold, so that the determined target state is more accurate.

In one embodiment, if a first number of target states of the same motion state is greater than a preset number threshold, it is determined that the target state of the fishing rod and/or fishing line meets a preset condition.

In this embodiment, the same motion state includes the rod-reeling state or the rod-casting state. Assuming that the quantity threshold is 5, if the rod-reeling state is 7, it is determined that the target state of the fishing rod and/or fishing line meets the preset condition.

In one embodiment, based on the motion data of the fishing rod and/or fishing line at multiple moments collected by the motion sensor, the first probabilities corresponding to each moment are determined, including: when the target state is a motion state, based on a preset time period, the first probabilities corresponding to each moment are obtained according to the motion data of the fishing rod and/or fishing line at each moment and a recurrent neural network model.

In this embodiment, once a stable casting or reeling action is detected, the target state will not be detected within the next preset time period, and the target state is assigned to “other state” by default. If the preset time period is exceeded, the first probabilities corresponding to each moment will be obtained based on the motion data of the fishing rod and/or fishing line at each moment and the recurrent neural network model, so as to store the pre-shot photos and/or pre-shot videos according to the first probabilities.

FIG. 10 is a flow chart of a method for determining a recurrent neural network model in an embodiment, as shown in FIG. 10, comprising the following steps:

S1001, obtaining motion data samples of a fishing rod and/or a fishing line and preset state samples corresponding to the motion data samples.

S1002, inputting the motion data samples into an initial recurrent neural network model to obtain predicted state samples.

S1003, training the initial recurrent neural network model according to the preset state samples, the predicted state samples and a cross entropy loss function to obtain the recurrent neural network model.

In one embodiment, a gyroscope is clamped on different types of fishing rods and/or fishing lines, allowing different users to simulate real casting and reeling fishing actions in real scenarios, and the motion data sample at each moment is intercepted and saved, and the preset state sample corresponding to each motion data sample is marked according to action information of whether the user is casting or reeling in the rod.

Based on the collected large amount of sequence data sets {motion data samples, preset state samples}, the initial recurrent neural network model is trained. That is, the motion data samples are input into the initial recurrent neural network model to obtain the predicted state samples, and the parameters of the initial recurrent neural network model are optimized according to the preset state samples, the predicted state samples and the cross entropy loss function, and the parameters of the network model with the minimum loss value of the cross entropy loss function are saved to obtain the recurrent neural network model.

In an embodiment of the present application, motion data samples of a fishing rod and/or a fishing line and preset state samples corresponding to the motion data samples are obtained, the motion data samples are input into an initial recurrent neural network model, a predicted state samples are obtained, and the initial recurrent neural network model is trained according to the preset state samples, the predicted state samples and the cross entropy loss function to obtain a recurrent neural network model. In an embodiment of the present application, the cross entropy loss function is used to train the initial recurrent neural network model to obtain a recurrent neural network model, which can avoid the gradient vanishing problem to a certain extent and can conveniently handle multi-classification problems.

It should be understood that, although the steps in the flowcharts involved in the above embodiments are displayed in sequence according to tindication of the arrows, these steps are not necessarily executed in sequence according to the order indicated by the arrows. Unless there is a clear explanation in this article, the execution of these steps is not strictly limited in order, and these steps can be executed in other orders. Moreover, at least a part of the steps in the flowcharts involved in the above embodiments may include multiple steps or multiple stages, and these steps or stages are not necessarily executed at the same time, but can be executed at different times, and the execution order of these steps or stages is not necessarily carried out in sequence, but can be executed in turn or alternately with other steps or at least a part of the steps or stages in other steps.

Based on the same inventive concept, one embodiment of the present application also provides a control device for implementing the control method of the above-mentioned photographing device. The implementation scheme for solving the problem provided by the device is similar to the implementation scheme recorded in the above-mentioned method, so the specific limitations in one or more video recognition device embodiments provided below can refer to the limitations of the control method for the photographing device above, and will not be repeated here.

In one embodiment, as shown in FIG. 11, a control device or controller for a photographing device is provided, comprising: an acquisition module 11 and a first storage module 12, wherein:

the acquisition module 11 is configured to acquire a target state of a target object when the photographing device is in a pre-shot mode;

the first storage module 12 is configured to store pre-shot photos and/or pre-shot videos of the photographing device within a preset time interval when the target state of the target object meets a preset condition; the preset time interval includes an interval from a moment when the target state of the target object meets the preset condition to a prior first preset moment before the moment.

In one embodiment, the preset time interval includes the time from when the target state of the target object meets the preset condition to a second preset time thereafter.

In one embodiment, the control device of the photographing device further includes:
a generation module, configured to generate a target video based on the pre-shot photos and/or pre-shot videos stored in the pre-shot mode.

In one embodiment, the control device of the photographing device further includes:
a second storage module, configured to store the current pre-shot photo and/or pre-shot video when the target state of the target object meets a preset condition.

In one embodiment, the acquisition module includes:
a detection unit, configured to detect a target fisherman in a first sampling frame in the pre-shot photo and/or the pre-shot video, and obtain a target detection frame of the target fisherman in the first sampling frame; and
a first determination unit, configured to input a region of interest corresponding to the target detection frame into a target detection model to obtain the target state of the target fisherman in the first sampling frame.

In one embodiment, the detection unit is also configured to sample the pre-shot photos and/or pre-shot videos to obtain a second sampling frame; detect the second sampling frame to obtain a detection result; if the detection result includes a target fisherman and a fishing rod, then detect the target fisherman in the first sampling frame to obtain the target detection frame of the target fisherman in the first sampling frame.

In one embodiment, the detection unit is also configured to detect the target fisherman in each first sampling frame to obtain a first detection frame of the target fisherman in each first sampling frame; and obtain a target detection frame of the target fisherman in each first sampling frame based on each first detection frame.

In one embodiment, the detection unit is further configured to enlarge each first detection frame to obtain each second detection frame; and obtain the target detection frame according to coordinate information of the second detection frame.

In one embodiment, the detection unit is also configured to use a minimum coordinate among each first coordinate as the first target coordinate, and a minimum coordinate among each second coordinate as the second target coordinate; a maximum coordinate among each third coordinate as the third target coordinate, and a maximum coordinate among each fourth coordinate as the fourth target coordinate; and obtain a target detection frame according to the first target coordinate, the second target coordinate, the third target coordinate and the fourth target coordinate.

In one embodiment, the first storage module includes:
a first control unit, configured to control the photographing device to enter a recording state when the target state of the target object satisfies a first preset condition; and
a second control unit, configured to control the photographing device to exit the recording state to store the pre-shot photos and/or pre-shot videos when the target state of the target object meets the second preset condition.

In one embodiment, the control device of the photographing device further includes:
a first determination module, configured to determine that the target state of the target fisherman satisfies a first preset condition if the target state of the target fisherman is a fishing line reeling in state; and
a second determination module, configured to determine that the target state of the target fisherman meets a second preset condition if the target state is not the fishing line reeling in state.

In one embodiment, the control device of the photographing device further includes:
a third determination module, configured to determine a distance between each fisherman and the fishing rod if the first sampling frame includes multiple fishermen; and
a fourth determination module, configured to take the fisherman corresponding to the shortest distance as the target fisherman.

In one embodiment, the acquisition module includes:
a third determination unit, configured to determine, when the photographing device is in a pre-shot mode, first probabilities corresponding to each moment according to the motion data of the fishing rod and/or the fishing line at multiple moments collected by the motion sensor; the first probabilities include probabilities of the fishing rod and/or the fishing line being in various preset states, and the various preset states includes at least a motion state;
a fourth determination unit, configured to determine the target state corresponding to each moment from the various preset states according to the first probabilities corresponding to each moment.

In one embodiment, the fourth determination unit is further configured to determine the maximum probability among the first probabilities corresponding to each moment; and determine the target state corresponding to each moment from various preset states according to the maximum probability at each moment and a preset probability threshold.

In one embodiment, the fourth determination unit is also configured to determine that the target state corresponding to the moment is a motion state if the preset state corresponding to the maximum probability is a motion state and the maximum probability is greater than a preset probability threshold; the motion state includes a casting rod state or a reeling rod state.

In one embodiment, the control device of the photographing device further includes:
a fifth determination unit, configured to determine that the target state of the fishing rod and/or fishing line meets the preset condition if a first number of target states of the same motion state is greater than a preset number threshold.

In one embodiment, the third determination unit is also configured to obtain the first probabilities corresponding to each moment based on the motion data of the fishing rod and/or fishing line at each moment and the recurrent neural network model based on a preset time period when the target state is a motion state.

In one embodiment, the acquisition module further includes:
an acquisition unit, configured to acquire motion data samples of a fishing rod and/or a fishing line and preset state samples corresponding to the motion data samples;
an input unit, configured to input the motion data samples into an initial recurrent neural network model to obtain predicted state samples; and
a training unit, configured to train the initial recurrent neural network model according to the preset state samples, the predicted state samples and a cross entropy loss function to obtain the recurrent neural network model.

In one embodiment, the photographing device includes any one of a sports camera, a panoramic camera, a drone, or a gimbal camera.

Each module in the above video recognition device can be implemented in whole or in part by software, hardware or a combination thereof. Each module can be embedded in or independent of a processor or circuitry in a computer device in the form of hardware, or can be stored in a memory in a computer device in the form of software, so that the processor can call and execute the operations corresponding to each module.

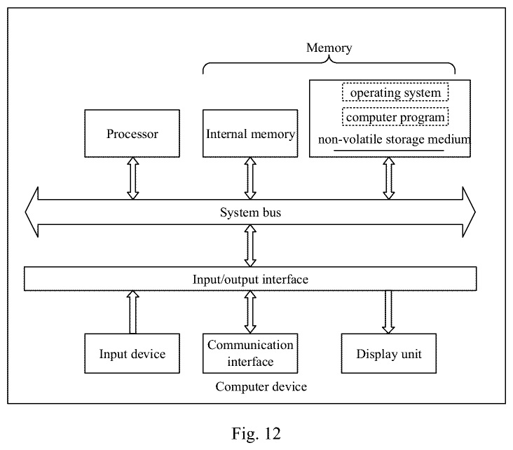

In one embodiment, a computer device is provided, which may be a terminal, and its internal structure diagram may be shown in FIG. 12. The computer device includes a processor, a memory, an input/output interface, a communication interface, a display unit, and an input device. The processor, the memory, and the input/output interface are connected via a system bus, and the communication interface, the display unit, and the input device are connected to the system bus via the input/output interface. The processor of the computer device is configured to provide computing and control capabilities. The memory of the computer device includes a non-volatile storage medium and an internal memory. The non-volatile storage medium stores an operating system and a computer program. The internal memory provides an environment for the operation of the operating system and the computer program in the non-volatile storage medium. The input/output interface of the computer device is configured to exchange information between the processor and an external device. The communication interface of the computer device is configured to communicate with an external terminal in a wired or wireless manner, and the wireless manner may be implemented through WIFI, a mobile cellular network, near field communication (NFC) or other technologies. When the computer program is executed by the processor, a control method of a photographing device is implemented. The display unit of the computer device is configured to form a visually visible image, which may be a display screen, a projection device, or a virtual reality imaging device. The display screen can be a liquid crystal display screen or an electronic ink display screen, and the input device of the computer device can be a touch layer covering the display screen, or a button, trackball or touchpad set on the computer device shell, or an external keyboard, touchpad or mouse.

Those skilled in the art will understand that the structure shown in FIG. 12 is merely a block diagram of a partial structure related to the solution of the present application, and does not constitute a limitation on the computer device to which the solution of the present application is applied. The specific computer device may include more or fewer components than those shown in the figure, or combine certain components, or have a different arrangement of components.

In one embodiment, a photographing device is also provided, including a photographing unit, a processor and a memory. The photographing unit is configured to collect pre-shot photos and/or pre-shot videos; the memory stores computer program instructions, and when the computer program instructions are executed by the processor, the steps in the above method embodiments are implemented.

In one embodiment, a computer-readable storage medium is provided, on which a computer program is stored. When the computer program is executed by a processor, the steps in the above-mentioned method embodiments are implemented.

The implementation principles and technical effects of the steps implemented when the computer program in this embodiment is executed by the processor are similar to the principles of the above-mentioned video continuation recording method, and will not be repeated here.

In one embodiment, a computer program product is provided, including a computer program, and when the computer program is executed by a processor, the steps in the above method embodiments are implemented.

The implementation principles and technical effects of the steps implemented when the computer program in this embodiment is executed by the processor are similar to the principles of the above-mentioned video continuation recording method, and will not be repeated here.

It should be noted that the user information (including but not limited to user device information, user personal information, etc.) and data (including but not limited to data used for analysis, stored data, displayed data, etc.) involved in this application are all information and data authorized by the user or fully authorized by all parties, and the collection, use and processing of relevant data must comply with relevant regulations.

A person of ordinary skill in the art can understand that all or part of the processes in the above-mentioned embodiment method can be completed by instructing the relevant hardware through a computer program, and the computer program can be stored in a non-volatile computer-readable storage medium. When the computer program is executed, it can include the processes of the embodiments of the above-mentioned methods. Among them, any reference to the memory, database or other medium used in the embodiments provided in the present application can include at least one of non-volatile and volatile memory. Non-volatile memory can include read-only memory (ROM), magnetic tape, floppy disk, flash memory, optical memory, high-density embedded non-volatile memory, resistive random access memory (ReRAM), magnetoresistive random access memory (MRAM), ferroelectric random access memory (FRAM), phase change memory (PCM), graphene memory, etc. Volatile memory can include random access memory (RAM) or external cache memory, etc. As an illustration and not limitation, RAM can be in various forms, such as static random access memory (SRAM) or dynamic random access memory (DRAM). The database involved in each embodiment provided in this application may include at least one of a relational database and a non-relational database. Non-relational databases may include distributed databases based on blockchains, etc., but are not limited to this. The processor involved in each embodiment provided in this application may be a general-purpose processor, a central processing unit, a graphics processor, a digital signal processor, a programmable logic unit, a data processing logic unit based on quantum computing, etc., but are not limited to this.

The technical features of the above embodiments may be combined arbitrarily. To make the description concise, not all possible combinations of the technical features in the above embodiments are described. However, as long as there is no contradiction in the combination of these technical features, they should be considered to be within the scope of this specification.

The above-described embodiments only express several implementation methods of the present application, and the descriptions thereof are relatively specific and detailed, but they cannot be understood as limiting the scope of the present application. It should be pointed out that, for a person of ordinary skill in the art, several variations and improvements can be made without departing from the concept of the present application, and these all belong to the protection scope of the present application. Therefore, the protection scope of the present application shall be subject to the attached claims.

What is claimed is:

1. A method for controlling a photographing device, comprising:
obtaining a target state of a target object;
determining that the target state of the target object meets a preset condition; and
storing pre-shot photos and/or pre-shot videos of the photographing device within a preset time interval,
wherein the photographing device is in a pre-shot mode, and the preset time interval includes an interval from a target moment when the target state of the target object meets the preset condition to a first preset moment prior to the target moment.

2. The method according to claim 1, wherein the preset time interval further includes another interval from the target moment when the target state of the target object meets the preset condition to a second preset time after the target moment.

3. The method according to claim 1, wherein, after the storing the pre-shot photos and/or pre-shot videos of the photographing device within the preset time interval, the method further comprises:
generating a target video based on the pre-shot photos and/or pre-shot videos stored in the pre-shot mode; and/or
storing current pre-shot photo and/or pre-shot video.

4. The method according to claim 1, wherein the target object is a target fisherman, and the obtaining the target state of the target object comprises:
detecting a target fisherman in a first sampling frame in the pre-shot photo and/or pre-shot video to obtain a target detection frame of the target fisherman in the first sampling frame; and
inputting a region of interest corresponding to the target detection frame into a target detection model to obtain the target state of the target fisherman in the first sampling frame.

5. The method according to claim 4, wherein the detecting the target fisherman in the first sampling frame in the pre-shot photo and/or pre-shot video to obtain the target detection frame of the target fisherman in the first sampling frame comprises:
sampling the pre-shot photo and/or pre-shot video to obtain a second sampling frame;
detecting the second sampling frame to obtain a detection result;
determining that the detection result includes the target fisherman and a fishing rod; and
detecting the target fisherman in the first sampling frame to obtain the target detection frame of the target fisherman in the first sampling frame.

6. The method according to claim 5, wherein there are multiple first sampling frames, and the detecting the target fisherman in the first sampling frame to obtain the target detection frame of the target fisherman in the first sampling frame comprises:
detecting the target fisherman in each of the first sampling frames to obtain a first detection frame of the target fisherman in each of the first sampling frames; and
obtaining a target detection frame of the target fisherman according to the first detection frame in each of the first sampling frames.

7. The method according to claim 6, wherein the obtaining the target detection frame of the target fisherman according to the first detection frame in each of the first sampling frames comprises:
enlarging first detection frames to obtain second detection frames;
obtaining the target detection frame according to coordinate information of the second detection frames.

8. The method according to claim 7, wherein the coordinate information of each of the second detection frame includes first coordinate information and second coordinate information, the first coordinate information includes a first coordinate and a second coordinate, and the second coordinate information includes a third coordinate and a fourth coordinate; and the obtaining the target detection frame according to the coordinate information of the second detection frame comprises:
determining a minimum coordinate among first coordinates of the second detection frames as a first target coordinate, and determining a minimum coordinate among second coordinates of the second detection frames as a second target coordinate;
determining a maximum coordinate among third coordinates of the second detection frames as a third target coordinate, and determining a maximum coordinate among fourth coordinates of the second detection frames as a fourth target coordinate; and
obtaining the target detection frame according to the first target coordinate, the second target coordinate, the third target coordinate and the fourth target coordinate.

9. The method according to claim 1, wherein the preset condition includes a first preset condition and a second preset condition, and the determining that the target state of the target object meets the preset condition and storing the pre-shot photos and/or pre-shot videos of the photographing device within a preset time interval comprises:
determining that the target state of the target object meets the first preset condition;
controlling the photographing device to enter a recording state; and
determining that the target state of the target object meets the second preset condition;
controlling the photographing device to exit the recording state to store the pre-shot photos and/or pre-shot videos.

10. The method according to claim 9, wherein the target object is a target fisherman, further comprising:
determining that the target state of the target fisherman meets the first preset condition when the target state of the target fisherman is a fishing line reeling in state; and
determining that the target state of the target fisherman meets the second preset condition when the target state of the target fisherman is not the fishing line reeling in state.

11. The method according to claim 4, further comprising:
determining that the first sampling frame includes a plurality of fishermen;
determining a distance between each of the fishermen and the fishing rod to obtain a plurality of distances; and
determining the fisherman corresponding to the shortest distance among the plurality of distances as the target fisherman.

12. The method according to claim 1, wherein the target object is a fishing rod and/or a fishing line, the obtaining the target state of the target object comprises:
determining first probabilities corresponding to each of multiple moments based on motion data of the fishing rod and/or the fishing line at the multiple moments collected by the motion sensor; the first probabilities include probabilities of the fishing rod and/or the fishing line being in various preset states respectively, and the various preset states include at least a motion state; and
determining the target state corresponding to each of the multiple moments from the various preset states according to the first probabilities corresponding to each of the multiple moments.

13. The method according to claim 12, wherein the determining the target state corresponding to each of the moments from the various preset states according to the first probabilities corresponding to each of the moments comprises:
determining a maximum probability among the first probabilities corresponding to each of the moments;
determining the target state corresponding to each of the moments from the various preset states according to the maximum probability at each of the moments and a preset probability threshold.

14. The method according to claim 13, wherein the determining the target state corresponding to each of the moments from the various preset states according to the maximum probability at each of the moments and the preset probability threshold comprises:
determining that the preset state corresponding to the maximum probability is the motion state, and the maximum probability is greater than the preset probability threshold; and
determining the motion state to be the target state corresponding to the moment, and the motion state includes a casting rod state or a reeling in rod state.

15. The method according to claim 12, further comprising:
determining that a first quantity of the target state being the same motion state is greater than a preset quantity threshold, and
determining that the target state of the fishing rod and/or fishing line meets the preset condition.

16. The method according to claim 12, wherein the determining the first probabilities corresponding to each of the multiple moments based on the motion data of the fishing rod and/or fishing line at the multiple moments collected by the motion sensor comprises:
determining that the target state is the motion state, obtaining the first probabilities of being the various preset states corresponding to each of the moments based on a preset duration periodically according to the motion data of the fishing rod and/or fishing line at each of the moments and a recurrent neural network model.

17. The method according to claim 1, after the determining that the target state of the target object meets the preset condition, further comprising:
switching the photographing device from a low-power identification state to a state of starting recording to drive the photographing device to start the storing.

18. The method according to claim 1, wherein the photographing device comprises one of a sports camera, a panoramic camera, a drone or a gimbal camera.

19. A photographing device, comprising at least one camera, at least one processor, and at least one memory, the at least one camera is configured to collect pre-shot photos and/or pre-shot videos; and the at least one memory stores computer program instructions,
wherein the at least one processor is configured to, when executing the computer program instruction, obtain a target state of a target object; determine that the target state of the target object meets a preset condition; and store pre-shot photos and/or pre-shot videos of the photographing device within a preset time interval,
wherein the photographing device is in a pre-shot mode, and the preset time interval includes an interval from a target moment when the target state of the target object meets the preset condition to a first preset moment prior to the target moment.

20. A system, comprising:
a photographing device configured to collect pre-shot photos and/or pre-shot videos; and
a controller to control the photographing device, the controller comprising at least one processor and at least one memory,
wherein the at least one memory stores computer program instructions, and the at least one processor is configured to, when executing the computer program instruction, obtain a target state of a target object; determine that the target state of the target object meets a preset condition; and store the pre-shot photos and/or pre-shot videos of the photographing device within a preset time interval,
wherein the photographing device is in a pre-shot mode, and the preset time interval includes an interval from a target moment when the target state of the target object meets the preset condition to a first preset moment prior to the target moment.
